(19) United States
(12) Patent Application Publication
(10) Pub. No.: US 2020/0361652 A1
(43) Pub. Date: Nov. 19, 2020

(54) TRAY FOR A STORAGE LIFT

(71) Applicant: Kardex Produktion Deutschland GmbH, Neuberg/Kammel (DE)

(72) Inventor: Norbert Bouche, Landau (DE)

(21) Appl. No.: 16/961,317

(22) PCT Filed: Jan. 15, 2019
(86) PCT No.: PCT/EP2019/050860

§ 371 Date: Jul. 10, 2020

(30) Foreign Application Priority Data
Jan. 24, 2018 (DE) 10 2018 201 127.3

(51) Int. Cl. B65D 1/34; B65D 1/44; B65G 1/04

(52) U.S. Cl. CPC B65D 1/34; B65G 1/04; B65D 1/44

(57) ABSTRACT

Tray for a storage lift, with a base for placing storage goods, wherein the tray is provided on at least one longitudinal side with at least one folded edge delimiting the base, wherein the folded edge extends substantially transversely to the base in a vertical section connected to the base. In order to provide a tray with an increased load-bearing capacity that is at the same time easy to manufacture, it is provided in the invention that the folded edge has at least one reinforcement section extending away from the vertical section, the vertical section and the at least one reinforcement section forming an obtuse angle between them.

Tray for a storage lift, having a base for placing storage goods, wherein the tray is provided on at least one longitudinal side with at least one folded edge which delimits the base, and wherein the folded edge runs substantially transversely to the base in a vertical section connected to the base.

Trays for storage lifts are well known. They are used to store storage goods in a storage lift and are usually movably mounted in such a lift. Trays must have sufficient load-bearing capacity for the storage goods to be stored.

As a rule, trays have folded edges on at least one of their longitudinal sides. Folded edges are also called upstands or folds. These folded edges can fulfill several tasks. First of all, they can form a wall that delimits the base to delimit the storage area. In particular, the vertical section can serve as a wall delimiting the base. In addition, the folded edges can be used to stiffen the tray. Finally, folded edges can also be used to move a tray. For example, folded edges can be shaped so that transport, lifting or traction devices can interact with the trays. For example, a transport device can be engaged with at least part of a folded edge to move the tray. When a tray is loaded, the folded edges can absorb forces so that the tray is prevented from bending. The folded edge prevents bending of the tray due to its area moment of inertia. Trays, in particular their folded edges, are usually manufactured from sheet metal materials or metal sheets by bending processes.

It is the object of the invention to provide a tray of the aforementioned type whose at least one folded edge can also withstand heavy loads on the tray due to loading of the tray base and can be easily manufactured.

For a tray of the type mentioned above, this object is solved by the fact that the folded edge has at least one reinforcement section extending away from the vertical section, the vertical section and the at least one reinforcement section enclosing an obtuse angle between them.

By means of the at least one reinforcement section, which extends away from the vertical section forming an obtuse angle to the vertical section, the area moment of inertia of the surface of the folded edge can be increased. This is achieved by increasing the height of the vertical section. However, the angle can simplify the production of the folded edge in comparison with a merely continuous straight course of the vertical section. In particular, the angle can prevent parts of the folded edge from colliding with bending tools. This applies in particular to the case that the folded edge has further elements which are connected to the reinforcement section. The obtuse angle can be used to create space for bending tools, such as punches, when forming the folded edge.

All in all, the folded edge according to the invention thus makes it possible to increase the stability of a tray without requiring new tools for bending. Instead, tools such as those used to form folded edges without the reinforcement section according to the invention can continue to be used. It should also be noted that the reinforcement section can increase the stability of the tray while maintaining the same thickness of the base material. Thus, the tray may have an increased stability compared to a tray which is made of a base material of the same thickness but does not have the reinforcement section according to the invention.

The obtuse angle refers to a cross-section through the folded edge transverse to the longitudinal side. The term “base of the tray” refers to a horizontal, preferably continuous, structure that limits a storage area for storage goods on the tray in a downward direction. The storage goods rest at least in sections on a base surface that is accessible from above.

It is not excluded that there may be other intermediate sections between the vertical section and the reinforcement section. However, these are preferably arranged directly adjacent to each other or merging into each other.

The solution according to the invention can be further improved by different, individually advantageous designs that can be combined with each other in any way. These embodiments and the advantages associated with them are described in the following.

The vertical section and the at least one reinforcement section may form an angle between 125° and 145° between them. This allows a good compromise to be achieved between an increased area moment of inertia per unit area and simplified manufacture. Preferably the angle is 135°±3°.

In order to allow undisturbed access to the base of the tray, the at least one reinforcement section, in particular with its end facing away from the vertical section, preferably extends away from the rest of the tray

According to another advantageous embodiment, the folded edge has at least one traction section at its distal end, which can be engaged by at least one traction element of a storage lift. The distal end is, in cross-section transverse to the longitudinal side, that end of the folded edge which is arranged at a distance from the rest of the tray, in particular its base.

To provide space for a finished tray for a means of transport, for example a traction device, and to provide space for a forming tool during manufacture of the tray, at least one spacer section may extend between the vertical section and the at least one traction section. The spacer section can space the traction section from the vertical section and at the same time connect them together. The at least one spacer section extends preferably from the reinforcement section to the traction section.

Alternatively, the spacer section can be identical to the reinforcement section or be an extension of it.

Preferably the at least one spacer section and the at least one reinforcement section enclose an angle between 70° and 110° between them. In particular, the sections may include an angle of 90°±3° between them.

The at least one spacer section can form with the at least one reinforcement section a substantially roof-shaped, in particular gable roof-shaped, cross-section, in particular transverse to the longitudinal side.

In order to prevent a traction device from slipping when the tray is pulled, the at least one traction section preferably extends transversely to the base. In particular, the at least one vertical traction section may extend parallel to the vertical section.

The tray is preferably formed as a bent part. It can, for example, be manufactured as a punched-bent part. However, processes other than punching are also possible, especially lasing. At least two, preferably all, of the following elements can be formed monolithically with each other: base, vertical section, reinforcement section, spacer section, traction section. However, this should not exclude the possibility of a multi-part tray.

As described above, the folded edge according to the invention ensures that the stability of the tray is increased. This means that a tray according to the invention can be loaded more heavily than a comparable tray without the folded edge according to the invention.

In order to also adapt the base of the tray to the higher load-bearing capacity conferred by the folded edge according to the invention, a further advantageous embodiment of the tray according to the invention is provided, in which the base of the tray is plastically deformed at at least one location spaced from at least one edge region.

This advantageous embodiment is described below. Although this embodiment represents a preferred embodiment of the tray according to the invention, the folded edge according to the invention is also advantageous for trays without the tray base described in more detail below.

The at least one plastically deformed area of the base can lead to a tension of the material of the base, especially the sheet metal material. This tension can in turn produce an upward curvature of the base, the upward curvature being related to a comparable tray without the at least one plastically deformed location. In other words, the base of the tray, which would sag downward by its own weight without the at least one plastically deformed location, may sag less by the at least one plastically deformed location, or may be horizontal or curved upward instead of sagging downward. The introduction of at least one plastically deformed location thus leads to a negative pretension in the base, or to the base arching upwards, compared to a tray without the at least one plastically deformed location according to the invention.

This indirect formation of the curvature can presumably be produced by displacing material of the base laterally, i.e. away from the at least one plastically deformed location, at the at least one plastically deformed location. This displacement of material can lead to a pressure in the base of the tray, in particular laterally directed pressure. Since the tray is usually limited to its sides and these sides may be stiffened, the base may react to the pressure generated by the plastic deformation by forming the curvature.

Due to the upward curvature of the base, the tray can be negatively preformed or negatively pre-tensioned in the unloaded state, i.e. without storage goods. If the tray is now loaded and the load acting on the base increases, the base will curved downwards. Due to the negative deformation upwards, the base is less curved downwards than would be the case with a comparable tray whose base does not show any plastically deformed area. In other words, when loaded by storage goods, the base must first overcome the upward curvature before it curves downwards due to the weight of the storage goods. In this way, a downward curvature of the base can be minimized. Compared to a tray without the plastically deformed area, the base of the tray according to the invention is therefore less strongly curved downwards under the same load. In this way, several trays can be placed on top of each other with a small vertical distance in a storage lift. Since the downward curvature is reduced compared to a conventional tray, the tray can therefore take a higher load for the same space requirements.

The at least one plastically deformed area shall be distinguished from the deformation of the tray caused by the plastically deformed area described above. While the at least one plastically deformed location is locally delimited in the base of the tray, in particular in relation to the surface area, the area of negative pre-tensioning or upward curvature refers to larger areas of the base, depending on the design, this area can also make up the majority of the base. For the sake of brevity, the term “sheet” will be used in the following for the term “sheet metal”. The tray, in particular the base, can be formed from a sheet. Alternatively or additionally, the tray can also be formed from a number of sheets. It is also not excluded that a finished tray may have other parts, so that it is composed of several individual parts. For example, the tray can also be provided with attached corner supports.

At the at least one plastically deformed location, the curved base may have an upward offset. In other words, the curved base may be offset upwards at least in sections at the at least one plastically deformed location. The upward offset of the base may increase the tendency for the deformation or pretension produced by the at least one plastically deformed location to be negative, or, in other words, for the curvature of the base to be upwardly oriented. The offset is preferably locally limited by the at least one plastically deformed location. In other words, a curvature of the base usually extends over a larger proportion of the base surface of the tray than the offset.

As described above, the negative pre-tensioning of the base can be created by introducing plastic deformation at at least one location in the base, i.e. indirectly. The at least one plastically deformed location preferably has a smaller extension over the base surface than the area of negative pre-tensioning or curvature. It should also be mentioned that the area of the negative pretension or the curvature of the base, preferably extends over at least ⅔ of the base surface, and particularly preferably over the entire base surface. In contrast, the at least one plastically deformed area preferably extends over less than 1/10 of the base surface.

Preferably the tray, especially its base, is substantially rectangular. The rectangular shape has narrow sides and longitudinal sides running at right angles to these. The longitudinal sides run parallel to a longitudinal direction of the tray and the narrow sides parallel to a depth direction of the tray. It is preferable to displace more material in the longitudinal direction of the tray than in the depth direction. This can increase the tendency to create negative pretension or upward curvature.

In order to effectively create a negative pretension in the base, the at least one plastically deformed location may be formed by an oblong recess. The oblong recess can be a bead, for example. The at least one oblong recess will preferably cause an upward offset of the base. The at least one oblong recess or the at least one bead can lead to the forces generated by the load and acting on the base, to which at least one folded edge according to the invention is directed.

According to another advantageous design, the base can be provided with a plurality of spaced longitudinal recesses. The at least one oblong recess extends with its longitudinal direction preferably parallel to the base. Preferably, the at least one oblong recess extends transversely to at least one edge of the tray.

The tray may be substantially oblong and a longitudinal direction of the at least one oblong recess may be substantially transverse to a longitudinal direction of the tray. This displaces more material in the longitudinal direction of the tray than transversely thereto so that the at least one oblong recess can contribute to the curvature of the base.

As an alternative to the orientation transverse to the longitudinal direction of the tray, the at least one longitudinal recess may also have a different orientation. In particular, the at least one oblong recess can run diagonally, i.e. with a directional component transverse to the longitudinal direction of the tray and with a directional component parallel to the longitudinal direction. It is also possible that the tray is provided with a plurality of oblong recesses which have different orientations. Preferably, the tray has a plurality of oblong recesses running parallel to each other. In particular, these can run parallel to each other in groups, or, in other words, form groups of parallel recesses.

According to a preferred design, the at least one oblong recess extends continuously along its longitudinal axis. Alternatively, the at least one oblong recess may be interrupted at at least one location. It is also possible to string a series of recesses, which do not necessarily have to be oblong, together along a longitudinal axis.

The at least one oblong recess, preferably all oblong recesses, if several are present, preferably has a length which is greater than ⅓, particularly preferably greater than ⅔ of a tray depth. This can effectively cause the curvature of the bottom. The tray depth refers to the depth of the tray bottom, i.e. the usable area.

If an offset is formed by the at least one plastically deformed location, this offset preferably has at least a height which at most corresponds to the thickness of the base. The thickness of the base means, in particular, the thickness of a sheet or the metal sheet material from which the base is formed. The height of the offset is determined in relation to the base surface. The preferred maximum height of the offset preferably also applies in the case that the at least one plastically deformed location is formed by an oblong recess in the form of a bead. This bead height, which is comparatively low for typical beads, may be sufficient to increase the load-bearing capacity of the tray, since the plastic deformation of the base caused by the beads is already sufficient to produce the negative pre-tensioning or the upward curvature of the base. The low height of the offset, especially of a bead, is advantageous in order not to unnecessarily restrict the volume of the storage area for storage goods above the base. In addition, the low height of the offset is advantageous when manufacturing the tray. In particular, if at least one offset is inserted before the lateral edges of the tray are formed by folding, the low height of the offset prevents the sheet from distorting so much by the insertion of the offset that further processing is made more difficult.

Preferably, the at least one offset has a height which is at least 0.25 times and at most 1 time, more preferably at least 0.4 times and at most 0.7 times the thickness of the base. A good compromise, which causes a sufficient curvature of the base and at the same time seems to be unproblematic from the manufacturing point of view, can be achieved by a height of the offset which corresponds approximately to 0.55 (±0.05) times the thickness of the base. For a sheet thickness of 2 mm, this corresponds to an offset height of 1.1±0.1 mm.

At least one of the oblong recesses, preferably all of them if there are several, may have a trapezoidal cross-section. The cross-section is seen transversely to the longitudinal direction of the oblong recess. The trapezoidal cross-section can be formed like a trapezoidal sheet, i.e., isosceles, symmetrical and offset with the short base side of the trapezoid upwards, i.e. into the storage area. On the one hand, such a cross-section can be advantageous for creating the curvature of the base. On the other hand, an oblong recess with such a cross-section, especially a bead, can be easily created. For manufacturing reasons, the trapezoidal cross-section described above can be rounded off. This means that the transitions between the rest of the base and the legs and the transitions from the legs to the short base side then do not have any sharp transitions, but merge into each other in a rounded manner. The legs and the short base side can also deviate from the straight course and be rounded for manufacturing reasons.

Alternatively, the at least one oblong recess may have a semicircular cross-section, with the convex side curved or offset into the storage area, i.e. upwards. Other cross-sectional shapes are also possible, especially those known for beads. Only as an example, here are mentioned box-shaped and triangular cross-section. In addition, it is also possible that not all longitudinal recesses have the same cross-section.

In accordance with an advantageous embodiment, the tray has a large number of oblong recesses, which are distributed equidistantly over the tray. The oblong recesses are preferably arranged with their longitudinal directions parallel to each other and transverse to the longitudinal directions at the same distance from each other. In addition, the oblong recesses are preferably aligned with each other. In other words, the ends of the oblong recesses in relation to their longitudinal directions can be arranged along a line parallel to the longitudinal direction of the tray.

As an alternative to the equidistant arrangement of the oblong recesses, they can also have a different distribution. For example, distances between two adjacent oblong recesses may decrease from the narrow sides of the tray towards the center of the tray. The distance between the two outermost adjacent oblong recesses closest to a narrow side may be more than twice as large as the distance between two innermost oblong recesses in the area of the center of the tray.

The oblong recesses are preferably distributed symmetrically over the tray. In particular, the oblong recesses can be distributed mirror-symmetrically with respect to a mirror plane running through the center of the tray and transversely to its longitudinal direction.

Parallel to the narrow sides of the tray, the oblong recesses are preferably arranged in the center, i.e. preferably at least one oblong recess on both longitudinal sides of the tray has a substantially equal edge distance, whereby manufacturing tolerances in the range of about 5% of the tray depth are possible.

As already described above, the tray is preferably formed as a punched and bent part. As an alternative or in addition to punch-bending, other forming techniques can also be used. Especially embossing or deep drawing. The tray is preferably formed as a stamped/bent part with embossed and/or deep-drawn areas. The at least one plastically deformed area, in particular the at least one oblong recess, is preferably formed monolithically with the base of the tray. In addition, preferably also the at least one folded edge according to the invention, preferably all folded edges, are formed monolithically with the base of the tray. In other words, the base of the tray, the at least one plastically deformed area and/or the at least one folded edge can be produced from a single sheet by forming.

In particular, at least one displacement body can be pressed into the base from below to create the at least one plastically deformed location. Such a displacement body may in particular be formed by a punch or a roller. The at least one plastically deformed location can also be formed by deep drawing and/or other suitable techniques.

The solution according to the invention makes it possible to increase the load-bearing capacity of a tray without additional stiffening elements such as welded-on beams or profiles. However, it is not impossible to provide a tray according to the invention with additional stiffening elements, even if it is provided with at least one oblong recess, for example. The possibility of attaching at least one profile under the base, which runs parallel or transverse to the longitudinal direction of the tray, is only mentioned as an example. Such a profile could be a double channel profile, for example.

The negative pretension of the bottom—if present—or the curvature preferably has a size of +2 to −15 mm, preferably −3 to −6 mm. The values<0 to −15 mm represent an upward curvature of the base. The values>0 to +2 mm represent a downward curvature. As already mentioned at the beginning, the tray according to the invention also benefits from a curvature in the range of >0 to 2 mm, provided that a tray without at least one plastically deformed location is more strongly curved downwards. The size is measured between the uppermost point and the lowermost point of the curvature or the curved base, respectively, in each case on the base surface or in each case on the bottom side of the base. The lowest point of the curvature may, for example, be located on the base in the immediate vicinity of a folded edge. The highest point of the curvature is usually in the center of the tray if exactly one curvature is present. If the tray is provided with additional stiffening, such as a built-in or attached profile, the uppermost point of the curvature is usually in the center of the non-stiffened surface of the base.

In the following, the invention is explained in more detail by way of example on the basis of various embodiments with reference to the drawings. The combinations of features shown as examples for the embodiments can be supplemented by further features according to the above mentioned design in accordance with the features of the tray according to the invention necessary for a certain application. Individual features can also be omitted from the described embodiments, also in accordance with the above design, if the effect of this feature in a specific application is not important.

The same reference numerals are always used in the drawings for elements with the same function and/or structure.

FIG. 1 shows a perspective representation of a first embodiment of a tray according to the invention;

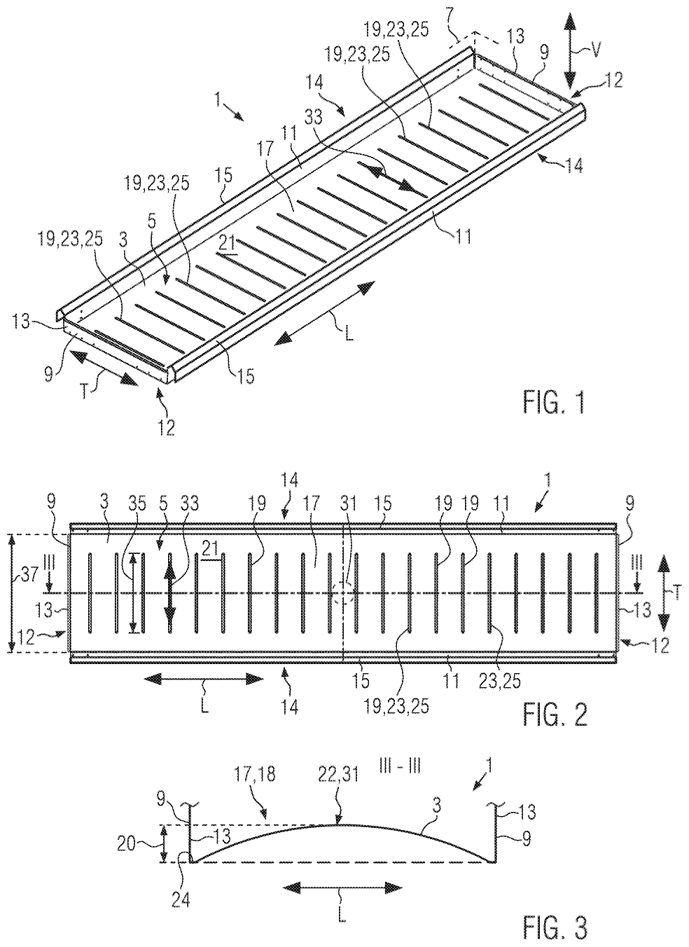

FIG. 2 shows a top view of the tray from FIG. 1;

FIG. 3 shows an exemplary exaggerated representation of the curvature of a tray according to the invention in a section through the center of the tray;

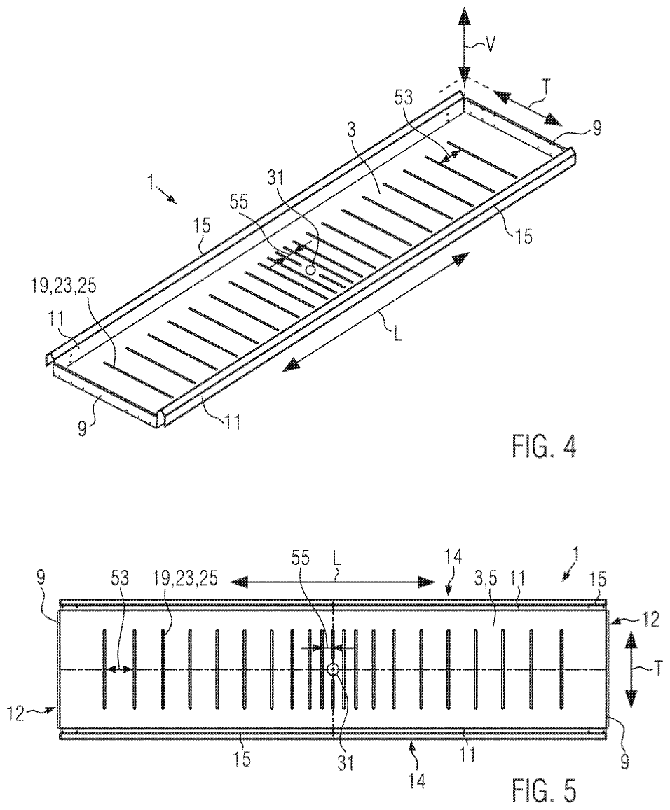

FIG. 4 shows a perspective representation of a second embodiment of a tray according to the invention;

FIG. 5 shows a top view of the tray from FIG. 4;

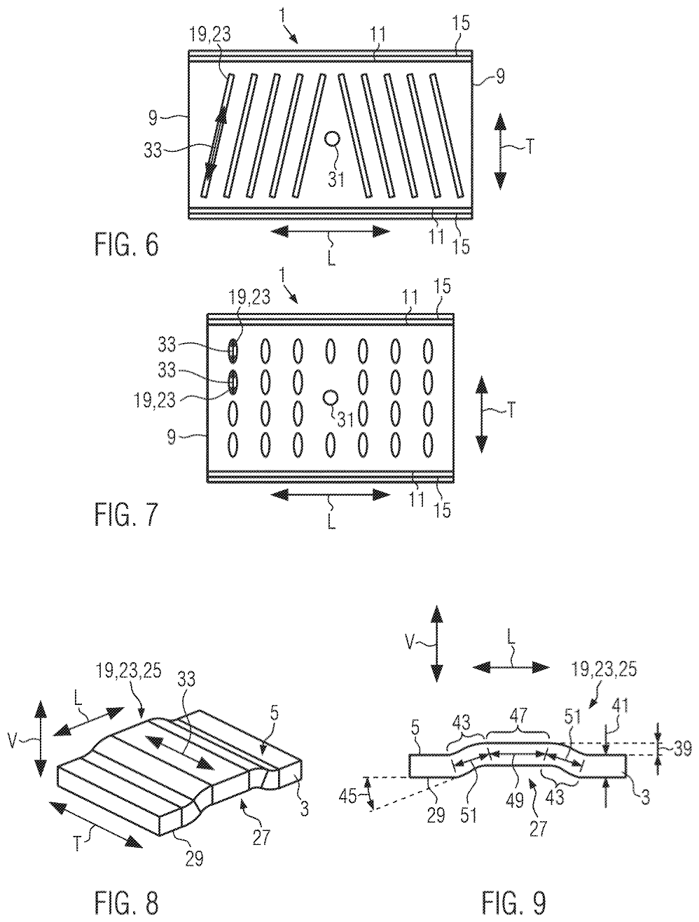

FIG. 6 shows a top view of another exemplary embodiment of a tray according to the invention;

FIG. 7 shows a top view of another exemplary embodiment of a tray according to the invention;

FIG. 8 shows a perspective, cut representation of an advantageous embodiment of an oblong recess;

FIG. 9 shows a cross-section through the oblong recess of FIG. 8;

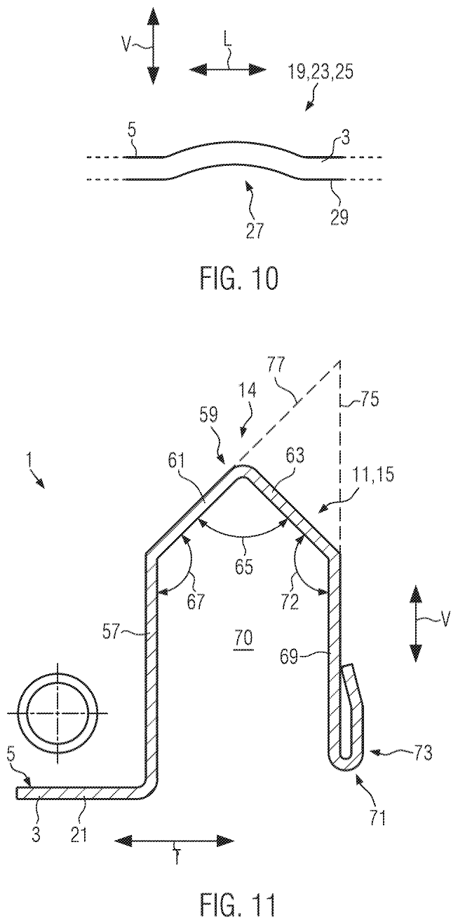

FIG. 10 shows a cross-section of another advantageous shape of oblong recess; and

FIG. 11 shows a cross-section through a tray according to the invention in the area of the folded edge.

In the following, the structure of a first advantageous embodiment of a tray 1 according to the invention is described with reference to FIGS. 1 and 2.

The tray 1 is used to store storage goods (not shown). For this purpose, the tray 1 has a base 3, whose base surface 5 is accessible from above. The base surface 5, on which the storage goods can be placed, represents the upper side of the base 3. The volume on which the storage goods can be placed is limited at the bottom by base 3. This volume represents a storage area 7 of the tray 1, which is indicated by dashed lines in FIG. 1.

The tray 1, or at least the base 3, has a substantially rectangular shape when viewed from above. The narrow sides 9 of the rectangle extend parallel to a tray depth or depth direction T. The longitudinal sides 11 of the rectangular shape run transversely to the narrow sides 9 and extend parallel to a longitudinal direction L of the tray. Since the tray 1 is usually accessible on at least one longitudinal side 11, the longitudinal direction L is equivalent to a width direction of the tray. Perpendicular to the longitudinal direction L and to the depth direction T is the vertical direction V of the tray, along which the height of the tray 1 extends.

On the narrow sides 9, the tray 1 has the folded edges 13 and on the longitudinal sides 11 the folded edges 15. The folded edges 13 and 15 serve on the one hand to delimit the base 3 and the base surface 5 transversely to the vertical direction V. On the other hand, the folded edges 13 and 15 absorb forces which are transmitted into them through the base 3. This stiffens the structure of the tray 1. Finally, the folded edges 13 and/or 15 can also be used to suspend or transport the tray 1.

A folded edge 15 according to the invention is described in detail below with reference to FIG. 11.

The narrow sides 9 and longitudinal sides 11 are usually formed from edge regions 12 and 14 of a sheet 21 from which the tray 1 is formed. The edge regions 12 are on the narrow sides 9 and the edge regions 14 on the longitudinal sides 11.

The base 3 can have a curvature 17 or a negative pretension. The base 3 is preferably curved upwards. The curvature 17 in an unloaded condition 18 is shown in FIG. 3 in a strongly exaggerated way. For comparison the dotted line in FIG. 3 should represent an uncurved tray base. The curvature 17 preferably extends over at least ⅔ of the base 3 or the base surface 5, more preferably over the entire base 3. The size or height 20 of the curvature 17 is preferably larger than a thickness 41 of the base 3 and is preferably between 5 and 15 mm. The height 20 is measured between an uppermost point 22 and a lowermost point 24 of the curvature 17. As the curvature 17 preferably extends over the entire base 3 of the tray 1, the uppermost point 22 is normally located in the area of the center 31 of the tray 1 or base 3. The lowest point 24 is normally located near a folded edge 13 or 15.

Due to the curvature 17 of the tray 3, the load capacity is increased compared to a tray without curvature. If storage goods are placed on the tray 5, the tray 3 initially lowers, making the curvature 17 flatter. In the case of a tray which is not curved even when unloaded (as indicated by the dotted line in FIG. 3), the base would already curve downwards under the same load. If the base is further loaded by taking up further storage goods, the base 3 of tray 1 will also curve downwards under a sufficiently strong load. However, this downward curvature is correspondingly less than would be the case with a comparable tray without previous upward curvature. The tray 1 curves downwards less under the same load than a tray without the curvature upwards. Since a large number of trays are arranged vertically one above the other in storage lifts, a higher density of trays in the storage lift can be achieved by using the tray 1 described here, since these can be arranged closer together along the vertical direction V. In contrast, with conventional trays that curve strongly downwards, a larger space must be kept free between two trays arranged one above the other. An upward curvature is not absolutely necessary.

Even in the unloaded condition 18, the tray 1 can have a horizontally running or even downward curved base 3. However, the base 3 is less strongly curved downwards than it would be in a comparable tray 1 without at least one plastically deformed location 19, which is discussed below.

Although the embodiment with a curvature 17 or at least one plastically deformed location 19 represents a preferred embodiment of the tray 1 according to the invention, the presence of the curvature 17 or at least one plastically deformed location 19 is not absolutely necessary. These elements merely serve to adapt the base 3 of the tray 1 to the increased load capacity of the folded edge 13 or 15 according to the invention. In other words, the base 3 should also be strengthened for an increased load-bearing capacity.

The curvature 17 of base 3 can be created indirectly. This means that a direct forming of curvature 17 itself by forming processes can be dispensed with. Instead, the base 3 is plastically deformed at at least one location 19. Preferably, the base 3 has a plurality of such plastically deformed locations 19. In FIGS. 1 and 2, not all plastically deformed locations 19 are marked with a reference numeral for the sake of clarity. The at least one plastically deformed location 19 is spaced from edge regions 12 and 14 of the tray 1.

In the plastically deformed locations 19, material of sheet 21, from which the base 3 is formed, is probably displaced laterally. More material is displaced in the longitudinal direction L than in the depth direction T. This displacement of material can lead to an elongation of the base 3 in longitudinal direction L. However, since the base 3 is prevented from increasing its surface area in the longitudinal direction L and/or in the depth direction T by the folded edge 13 and 15, it curves upwards along the vertical direction V.

At least one of the plastically deformed locations 19, preferably all plastically deformed locations 19, are monolithic, i.e. formed in one piece with the base 3 from the material of the sheet metal 21, hereinafter “sheet 21”. Preferably, the plastically deformed locations 19 are inserted into the sheet 21 before the folded edges 13 and 15 are formed.

In a preferred embodiment, the plastically deformed locations 19 are formed as oblong recesses 23. The oblong recesses 23 preferably represent beads 25. Such an oblong recess 23 or bead 25 is shown in detail in FIGS. 8 and 9. These Figures should also be referred to here.

Each of the plastically deformed locations 19 preferably represents an upward offset 27 of the base 3. In this case, the term “recess” 23 thus refers to a recess 23 on the underside 29, through which the base 3 is pushed upwards from the underside 29.

The oblong recesses 23 of the first embodiment run parallel to each other and to the narrow sides 9. In the depth direction T, the oblong recesses 23 are aligned with each other so that they all end with both ends at imaginary lines running parallel to the longitudinal sides 11. It is preferable that the oblong recesses 23 are equidistant.

The center 31 of the tray 3 is preferably free of plastically deformed locations 19, whereby the center 31 refers to the center of the tray area 5 when viewing the tray 3 from above. This can be advantageous in order to hold the tray 1 during its manufacture or the sheet 21 during its forming at its center 31, for example by means of a turntable of a punch-bending machine.

Along the depth direction T, the oblong recesses 23 are preferably arranged centrally between the longitudinal sides 11 of the tray 1. This means that the distances between the oblong recesses 23 and the longitudinal sides 11 or the folded edge 13 or 15 are essentially the same on both longitudinal sides 11, whereby manufacturing tolerances in the range of 5% are possible.

The oblong recesses 23 extend along longitudinal directions 33, which are preferably perpendicular to the longitudinal direction L of the tray 1. Along each of the longitudinal directions 33, the oblong recesses 23 preferably have a length 35 which is more than ⅓±10% of the depth 37 of the tray 1. In particular, the oblong recesses 23 each preferably have a length 35 which is more than ⅓±10% of the depth 37 of the tray 1. The depth 37 of the tray 1 refers to the depth 37 of the base surface 5.

The offset 27 preferably has a height 39 which is at most as large as the thickness 41 of the base 3, the height 39 of the offset 27 being measured from the base surface 5 on the offset 27 in relation to the base surface 5 in a non-upset area. The thickness 41 of the base 3 is preferably equal to the thickness of the sheet 21 used to manufacture the base 3. In particular, the height 39 of the offset 27 is preferably 0.4 to 0.7 times the thickness 41. The height 39 of the offset 27 is therefore preferably less than the height 20 of the curvature 17.

In the case where the at least one plastically deformed location 19 is formed by a bead 25, the height 39 of the offset 27 corresponds to the bead height. Alternatively, the at least one offset 27 may also have a height 39 which is greater than the thickness 41 of the base 3.

According to an advantageous embodiment, as also shown in FIGS. 8 and 9, the at least one oblong recess 23 or the bead 25 has a cross-section transverse to the longitudinal direction 33 of the oblong recess 23, which is trapezoidal in shape. In other words, the oblong recess 23 has, in cross-section, two mutually mirror-symmetrical legs 43, which run at an angle 45 to the undeformed base surface 5. The angle 45 is preferably between 25° and 35°. Between the two legs 43 extends the essentially straight area 47. The straight area 47 preferably has a length 49 extending transversely to the longitudinal direction 33 of the oblong recess 23, which is longer than the lengths 51 of the legs 43. The oblong recess 23 thus has a flat shape overall. The straight area 47 does not necessarily have to be exactly straight. It may also have a slight upward curvature for manufacturing reasons.

Alternatively or additionally, at least one oblong recess 23 may have a semicircular cross-section. In the case of a semicircular cross-section, the convex side preferably curves upwards into the storage area 7. Such a cross-section is shown in FIG. 10. Since the trapezoidal cross-section from FIGS. 8 and 9 does not necessarily have sharp transitions for manufacturing reasons, these may also be rounded, so that the cross-sectional shape may resemble the semicircular shape of FIG. 10 overall. The rounder the transitions are, the closer the trapezoidal shape comes to the semicircular shape. In addition, other cross-sections are also possible, especially those known for beading.

The following describes another advantageous embodiment of a tray 1 according to the invention with reference to FIGS. 4 and 5. For the sake of brevity, only the differences to the embodiment described with reference to FIGS. 1 and 2 are discussed.

The second embodiment of the tray 1 according to the invention differs from the first embodiment described with reference to FIGS. 1 and 2 in that the oblong recesses 23 and the beads 25, respectively, are not distributed equidistantly along the longitudinal direction L of the tray 1. Instead, the distances between two oblong recesses 23 decrease from the narrow sides 9 to the center of the tray 31.

The distribution of the oblong recesses 23 in the longitudinal direction L is preferably mirror-symmetrical with respect to a mirror plane passing through the center 31 and transverse to the longitudinal direction L. The distance 53 between the two outermost oblong recesses 23 is more than twice as large as the distance 55 between the two oblong recesses 23 closest to the center 31.

At the level of the center of the tray 31 there is an oblong recess 23, which is interrupted in the area of the center 31 in order to keep the center 31 itself free, as in the previously described embodiment, especially for the turntable of a punch-bending machine.

FIGS. 6 and 7 show only schematically two further examples of the design of plastically deformed locations 19 of the tray 1 in accordance with the invention. The plastically deformed locations 19 of the tray 1 in FIG. 6 are formed as oblong recesses 23, which may be shaped like the oblong recesses 23 described above.

However, unlike the embodiment described with reference to FIGS. 1 and 2, the longitudinal directions of the oblong recesses 23 do not run parallel to the narrow sides 9 or perpendicular to the longitudinal sides 11. Instead, the oblong recesses 23 are arranged at an angle of less than 45° to the narrow sides 9. The oblong recesses 23 run parallel in groups. Again, the distribution of the oblong recesses 23 is preferably symmetrical with respect to a mirror plane running through the center 31 and transversely to the longitudinal direction L.

Only as an example, the oblong recesses 23 on one half of the tray are equidistant from each other. Alternatively, the distances between two adjacent oblong recesses 23 can also vary.

Another possible design of the plastically deformed locations 19 is shown in FIG. 7. The design is similar to the first embodiment described with reference to FIGS. 1 and 2.

In contrast to the first embodiment, however, the oblong recesses 23 are not continuous. Instead, the embodiment shown in FIG. 7 has rows of oblong recesses 23, which extend along the depth direction T of the tray 1. Each of the oblong recesses 23 has a longitudinal direction 33, which preferably also runs parallel to the depth direction T. In other words, this design is similar to that of the first embodiment, with the difference that the oblong recesses 23 are interrupted several times.

FIG. 11 shows a cross-section of a folded edge 15 of a longitudinal side 11. The opposite folded edge 15 can also be shaped accordingly. In the following, however, the folded edge according to the invention is only described with reference to a folded edge 15. It is also possible that at least one of the folded edges 13 is shaped according to the invention.

The at least one folded edge 15 is preferably monolithic with the base 3 formed from sheet 21 by forming or edging. The base 3 can be provided with at least one plastically deformed location 19. However, this is not mandatory.

The folded edge 15 has a vertical section 57, which extends upwards at right angles to the base 3, i.e. along the vertical direction V. The vertical section 57 delimits the base 3 of tray 1 and forms a side wall for the tray 1.

The vertical section 57 is followed by a roof-shaped section 59. The roof-shaped section 59 is arranged in such a way that it does not overlap with the base 3 or the base surface 5 when viewed in vertical direction V.

The roof-shaped section 59 preferably has the shape of a gable roof. The roof shape is formed by sections 61 and 63, which enclose an angle 65 between them. The angle 65 is preferably between 70° and 110°, preferably 85° to 95°. The section 61 represents a reinforcement section 61 of the folded edge 15. The reinforcement section 61 extends the vertical section 57 upwards. As a result, the area moment of inertia of the vertical section 57 or the folded edge 15 is increased and the tray 1 can support a higher load. The section 63 represents a spacer section 63 of the folded edge 15. This is discussed further below.

The reinforcement section 61 and the vertical section 57 enclose the obtuse angle 67 between them. The angle 67 is preferably between 125° and 145°, more preferably 135°±3°.

At its distal end 71 the folded edge 15 has the vertical traction section 69. The vertical traction section 69 preferably runs parallel to the vertical section 57. The traction section 69 and the vertical section 57 span a receiving space 70 between them. The receiving space 70 can be used to receive a traction means, for example a hook or finger of a traction device. Such a device can rest against the traction section 69 and pull the tray 1. Such a device can also rest on the vertical section 57 and push the tray 1. The distance between the traction section 69 and the vertical section 57 can be adjusted by the spacer section 63, provided that the vertical section 57 and the reinforcement section 61 have a predetermined shape.

Preferably, the spacer section 63 is mirror-symmetrical in cross-section to the reinforcement section 61. Here, a mirror axis runs parallel to the vertical section 57 and along the depth direction T centrally between sections 61 and 63. This creates the symmetrical gable roof shape. In such a symmetrical arrangement, the angle 72 between the spacer section 63 and the traction section 69 corresponds to the angle 67.

At its distal end 71, the folded edge 15 may have a fold 73, in which material of the sheet 21 is folded up and onto the traction section 69.

The folded edge according to the invention 15 is not limited to the form described above. This is merely an advantageous embodiment. Only as an example, FIG. 11 shows by means of the dotted line, which is provided with reference numeral 75, a further possible embodiment of a folded edge 15 according to the invention.

In the further embodiment, the reinforcement section 61 and the spacer section 63 are identical. In other words, the spacer section 63 extends the reinforcement section 61. From this common section 77, the traction section 69 extends vertically downwards. An acute angle is enclosed between the common section 77 and the traction section 69.

As an alternative to the two embodiments described above, embodiments are also possible which represent intermediate solutions between the embodiments described above. For example, the reinforcement section 61 of the first embodiment can extend further along the dotted line and then be connected to the traction section 69 via a steeper spacer section 63.

Furthermore, it is possible that the folded edge 15 has a semicircular shape in cross-section. In this way, the reinforcement section 61 and the spacer section 63 can each have the shape of a quarter circle in cross-section, so that the overall shape is that of a semicircle. A parabolic shape is also possible in which the ascending reinforcement section 61 merges into the descending spacer section 63.

### LIST OF REFERENCE SIGNS

1 Tray
3 Base
5 Base surface
7 Storage area
9 Narrow side
11 Longitudinal side
12 Edge region
13 Folded edge
14 Edge region
15 Folded edge
17 Curvature
18 Unloaded condition
19 Plastically deformed location
20 Height of curvature
21 Sheet material
22 Uppermost point of curvature
23 Recess
24 Lowermost point of the curvature
25 Bead
27 Offset
29 Underside of the base
31 Center of the tray
33 Longitudinal direction of an oblong recess
35 Length of an oblong recess
37 Depth of the tray
39 Height of the offset
41 Strength of the base
43 Leg
45 Angle
47 Straight area
49 Length of the straight area
51 Leg length
53 Distance between outer oblong recesses
55 Distance between inner oblong recesses
57 Vertical section
59 Roof-shaped section
61 Reinforcement section
63 Spacer section
65 Angle between reinforcement section and spacer section
67 Angle between vertical section and reinforcement section
69 Vertical traction section
70 Receiving space
71 Distal end of the folded edge
72 Angle between spacer section and traction section
73 Fold
75 Further embodiment
77 Joint section
L Longitudinal direction
T Depth direction
V Vertical direction

1. A device for a tray for a storage lift, with a base for placing storage goods, wherein the tray is provided on at least one longitudinal side with at least one folded edge delimiting the base, and wherein the folded edge extends substantially transversely to the base in a vertical section connected to the base, wherein the folded edge has at least one reinforcement section extending away from the vertical section, the vertical section and the at least one reinforcement section forming an obtuse angle therebetween.

2. The device according to claim 1, wherein the vertical section and the at least one reinforcement section form an angle between them of between 125° and 145°.

3. The device according to claim 1, wherein the at least one reinforcement section extends away from the rest of the tray.

4. The device according to claim 1, wherein the folded edge has at its distal end at least one traction section on which at least one traction element of a storage lift can engage.

5. The device according to claim 4, wherein the folded edge comprises at least one spacer section extending between the vertical section and the at least one traction section.

6. The device according to claim 5, wherein the spacer section is identical to the reinforcement section.

7. The device according to claim 5, wherein the at least one spacer section and the at least one reinforcement section form an angle between them of between 70° and 110°.

8. The device according to claim 5, the at least one spacer section forms with the at least one reinforcement section a substantially roof-shaped, in particular gable roof-shaped, cross-section.

9. The device according to claim 4, wherein the at least one traction section extends transversely to the base.

10. The device according to claim 4, wherein the at least one vertical traction section runs parallel to the vertical section.

11. The device according to claim 1, characterized in that the tray is formed as a bent part.

12. The device according to claim 1, wherein at least two, preferably all, of the following elements are monolithically formed together: base, vertical section, reinforcement section, spacer section, traction section.

13. The device according to claim 1, wherein the base of the tray has at least one bead at at least one location spaced from at least one edge region.
